(19) United States
(12) Patent Application Publication
(10) Pub. No.: US 2004/0246276 A1
(43) Pub. Date: Dec. 9, 2004

(54) Image display device and image display system

(75) Inventor: Fumio Koyama, Shiojiri-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/841,633

(22) Filed: May 10, 2004

(30) Foreign Application Priority Data
May 30, 2003 (JP) 2003-154645

(51) Int. Cl. G09G 5/10

(52) U.S. Cl. 345/690

(57) ABSTRACT

The invention provides an image display device, an image display system, and a projector that enable an adjuster to easily verify whether colors that appear to be identical are actually identical or different for image adjustment. An image display device according to the invention includes a superimposing part that superimposes a cursor image on a position specified by an external source and located in an image of an input image signal, a first display that displays an image processed by the superimposing part, a gray-scale acquisition part that acquires the gray scale of the image signal corresponding to the specified position from the image signal, and a gray-scale output part that outputs the gray scale acquired by the gray-scale acquisition part.

### BACKGROUND OF THE INVENTION

1. Field of Invention

The present invention relates to an image display device, an image display system, and a projector that provide easy image adjustment.

2. Description of Related Art

Related art image display devices, including projectors, use lookup tables to correct the gray scale of image data and obtain a desired image. Prior to the shipment of such devices, an adjuster manipulates data in the lookup tables while watching an image projected on a screen, and makes an adjustment so as to obtain a desired image.

An example of this image adjustment is disclosed in Japanese Unexamined Patent Application Publication No. 7-141329.

### SUMMARY OF THE INVENTION

This related art image adjustment, however, is subject to the following problem. When an adjuster watches an image projected on a screen and makes an adjustment so as to obtain a desired image and adjacent colors are different, identical colors in an image may appear to be different. This causes the problem where an adjuster cannot adjust an image appropriately, even if he or she sees such an image and tries to adjust a desired color.

The invention addresses or solves the above and/or other problems, and provides an image display device, an image display system, and a projector that easily verify whether colors that appear to be identical are actually identical or different for image adjustment.

In order to address or achieve at least a part of the above, an image display device according to one aspect of the invention includes a superimposing part that superimposes a cursor image on a position specified by an external source and located in an image of an input image signal, a first display that displays an image processed by the superimposing part, a gray-scale acquisition part that acquires the gray scale of the image signal corresponding to the specified position from the image signal, and a gray-scale output part that outputs the gray scale acquired by the gray-scale acquisition part.

This configuration of the image display device of the present aspect of the invention enables an adjuster who makes an image adjustment to see the gray scale of the specified position in an image displayed on the display by sending a predetermined command. Thus, the adjuster easily verifies whether colors that appear to be identical are actually identical or different.

An image display device according to another aspect of the invention includes a superimposing part that superimposes a cursor image on a position specified by an external source and located in an image of an input image signal, a display that displays an image processed by the superimposing part, and a gray-scale acquisition part that acquires the gray scale of the image signal corresponding to the specified position from the image signal. The gray scale acquired by the gray-scale acquisition part is displayed on the display.

This configuration of the image display device of the present aspect of the invention enables an adjuster who makes an image adjustment to see the gray scale of the specified position in an image displayed on the display by sending a predetermined command. Thus, the adjuster easily verifies whether colors that appear to be identical are actually identical or different while watching the image on the display.

The image display device according to the invention may also include a coordinate obtaining part that obtains the coordinates of the specified position. The coordinates obtained by the coordinate obtaining part as well as the gray scale may be displayed on the display.

This configuration enables the adjuster to see the coordinates as well as the gray scale of the specified position by watching the display.

The image display device according to the invention may be a projector.

An image display system according to the invention includes the above-mentioned image display device and a computer that is coupled to the image display device. The computer includes a second display and a gray-scale input part that inputs the gray scale output from the gray-scale output part. The gray scale input to the gray-scale input part is displayed on the second display.

This configuration of the image display system of the invention enables an adjuster who makes an image adjustment to see the gray scale of the specified position in an image displayed on the display by sending a predetermined command from the computer. Thus, the adjuster easily verifies whether colors that appear to be identical are actually identical or different.

In the image display system according to the invention, the image display device may also include a coordinate obtaining part that obtains the coordinates of the specified position. The coordinates obtained by the coordinate obtaining part as well as the gray scale may be displayed on the second display.

This configuration enables the adjuster to see the coordinates as well as the gray scale of the specified position by watching the second display.

### BRIEF DESCRIPTION OF THE DRAWINGS

FIG. 1 is a schematic that shows a projector 100 according to a first exemplary embodiment of the invention;

FIG. 2 is a gray-scale correction graph showing a lookup table for correcting the gray scale of the R signal component included in the gray-scale correction part 60 in its initial condition;

FIG. 3 is a gamma-correction graph showing a gamma-correction table of the R component included in the gamma-correction part 70;

FIG. 4 shows an example of the coordinates (x, y) and the gray scale (r, g, b) of each R, G, B component of the position displayed on the monitor 230;

FIG. 5 is a gray-scale correction graph showing an example of gray-scale correction curves; and

FIG. 6 is a schematic that shows an example of the display on the screen SCR when making an image adjustment of the projector 100 according to an exemplary embodiment of the invention.

### DETAILED DESCRIPTION OF PREFERRED EMBODIMENTS

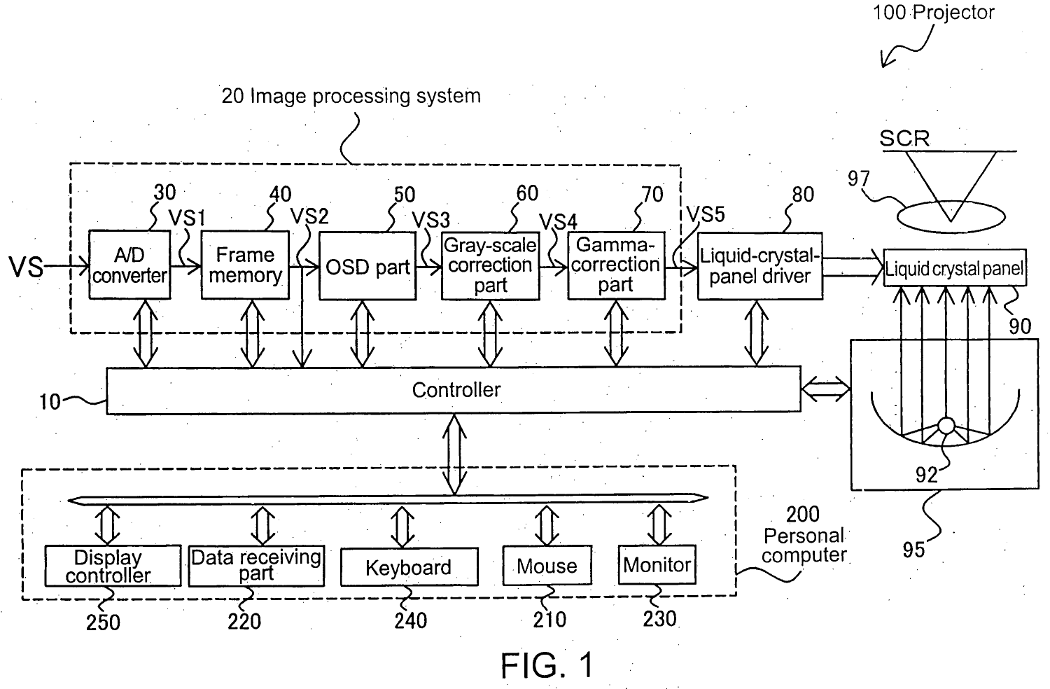

FIG. 1 is a schematic that shows a projector 100 according to a first exemplary embodiment of the invention.

The projector 100 includes a controller 10, a liquid crystal panel 90 as an optical modulator, an image processing system 20, a liquid-crystal-panel driver 80, a light-source lamp unit 95 including a light-source lamp 92, and a projection optical system 97. The image processing system 20 processes images based on an image signal “VS” input from an external source. The liquid-crystal-panel driver 80 drives the liquid crystal panel 90 based on an image signal output from the image processing system 20. The projection optical system 97 projects light illuminated by the light-source lamp 92 and modulated by the liquid crystal panel 90 on a screen “SCR”. The image processing system 20 further includes an A/D converter 30, a frame memory 40, an on-screen-display (OSD) part 50, a gray-scale correction part 60, and a gamma-correction part 70. The A/D converter 30 converts the image signal “VS”, which is input as an analog signal, to a digital image signal “VS1”. The frame memory 40 temporarily stores the image signal “VS1” output from the A/D converter 30. The OSD part 50 superimposes various images on an image of an image signal “VS2” read out from the frame memory 40. The gray-scale correction part 60 corrects the gray scale of an image signal “VS3” output from the OSD part 50. The gamma-correction part 70 performs gamma correction for an image signal “VS4” output from the gray-scale correction part 60.

The controller 10 includes a computer having a CPU and memories, such as ROM and RAM, and controls the A/D converter 30, the frame memory 40, the OSD part 50, the gray-scale correction part 60, the gamma-correction part 70, the liquid-crystal-panel driver 80, the light-source lamp unit 95, etc., in accordance with various programs stored in the ROM in order to project and display an image, for example. The ROM also stores menu images and cursor marks.

The projector 100 is coupled to a personal computer 200 by an exclusive cable. When a prepared program starts running, the personal computer 200 transmits a mode switching signal, which is described in greater detail below, to the controller 10 of the projector 100 by the cable. The personal computer 200 includes a mouse 210, a data receiving part 220, a monitor 230, a keyboard 240, and a display controller 250.

The operation of the projector 100 and the personal computer 200 are described below referring to FIG. 1.

The analog image signal “VS” input to the projector 100 is converted to the digital image signal “VS1” by the A/D converter 30. The image signal “VS1” is then written in the frame memory 40, processed as required by the controller 10, and read out as the image signal “VS2” based on timing of vertical synchronization signals (Vsync), horizontal synchronization signals (Hsync), clock signals, etc., generated by the controller 10. Various images, such as menu images stored in the ROM, are superimposed on an image of the image signal “VS2” by the OSD part 50, and then the signal is output as the image signal “VS3”. Subsequently, the gray scale of each R, G, B component of the image signal “VS3” is corrected by the gray-scale correction part 60, and then the signal is output as the image signal “VS4”.

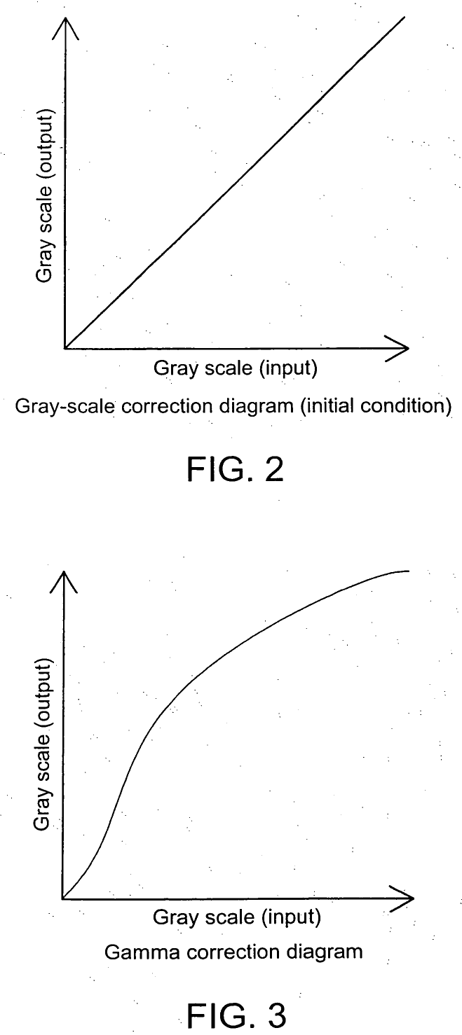

The gray-scale correction part 60 includes lookup tables to correct the gray scale of each R, G, B signal component. FIG. 2 is a gray-scale correction graph schematically showing a lookup table to correct the gray scale of the R component included in the gray-scale correction part 60 in its initial condition. The graph shows the input-output relation of the gray scale of the R component, with the input to the gray-scale correction part 60 plotted on the horizontal axis and the output from the gray-scale correction part 60 on the vertical axis.

The gray-scale correction part 60 in its initial condition outputs the same gray scale as the input as shown in FIG. 2. Therefore, no gray-scale correction of the R component is made for the gray-scale correction part 60 in its initial condition. The input-output relation of the gray scale of the G and B components shows the same pattern as the gray scale of the R component; therefore no gray-scale correction of the G and B components is made. An image adjustment for the projector 100, which is described in greater detail below, provides desired gray-scale correction by the gray-scale correction part 60 by adjusting the lookup tables for gray-scale correction in the gray-scale correction part 60.

Subsequently, the gamma-correction part 70 performs gamma correction for each R, G, B component of the image signal “VS4”, outputting the image signal “VS4” as an image signal “VS5”.

The gamma-correction part 70 includes lookup tables for gamma-correction of each R, G, B signal component. FIG. 3 is a gamma-correction graph schematically showing a lookup table for gamma correction of the R component in the gamma-correction part 70. The graph shows the input-output relation of the gray scale of the R component, with the input to the gamma-correction part 70 plotted on the horizontal axis and the output from the gamma-correction part 70 on the vertical axis.

The gray scale of the R component is converted in accordance with the corresponding lookup table for gamma correction, and thus gamma correction is provided. In the same manner, gamma correction for the G and B components is also provided by using the corresponding lookup tables for gamma correction.

Subsequently, the liquid-crystal-panel driver 80 drives the liquid crystal panel 90 in accordance with the image signal “VS5”. Light illuminated by the light-source lamp unit 95 is modulated by the liquid crystal panel 90 that is driven. The modulated light is then emitted from the liquid crystal panel 90, and projected through the projection optical system 97. Thus, the image is projected and displayed on the screen SCR.

An exemplary image adjustment of the projector 100 made by an adjuster operating the personal computer 200 prior to the shipment is described below.

The adjuster inputs the image signal “VS” for examining an image to the projector 100. As a result, an examination image is projected and displayed on the screen SCR based on the image signal.

Next, the adjuster operates the personal computer 200 and starts a prepared program. The personal computer 200 transmits a mode switching signal to the controller 10 of the projector 100 in response. When the controller 10 receives the mode switching signal, the projector 100 is switched to a gray-scale acquisition mode.

In the gray-scale acquisition mode, the OSD part 50 of the projector 100 superimposes a cursor mark stored in the ROM on an image of the image signal “VS2”. As a result, the cursor mark is superimposed on a predetermined position of the image projected and displayed on the screen SCR.

The adjuster then watches the image on the screen SCR and operates the mouse 210 of the personal computer 200. As the adjuster specifies a position of color adjustment with the cursor mark, the personal computer 200 outputs a displacement signal based on the operation of the mouse 210 to the controller 10 of the projector 100.

The controller 10 identifies the position on the image on the screen SCR specified by the cursor mark based on the displacement signal, and obtains the coordinates (x, y) of the position.

The controller 10 also loads the image signal “VS2” output from the frame memory 40, counts the number of pulses of horizontal synchronization signals from the rise of vertical synchronization signals (Vsync) based on the obtained y-coordinate, and identifies a horizontal scanning period including the above-mentioned position of the image signal “VS2”. Furthermore, the controller 10 counts the number of pulses of clock signals from the rise of corresponding horizontal synchronization signals (Hsync) based on the x-coordinate, and identifies the timing corresponding to the position in the horizontal scanning period. Based on the timing, the controller 10 samples the R, G, and B signal components of the image signal “VS2”, and outputs the gray scale (r, g, b) of each R, G, B component by the exclusive cable.

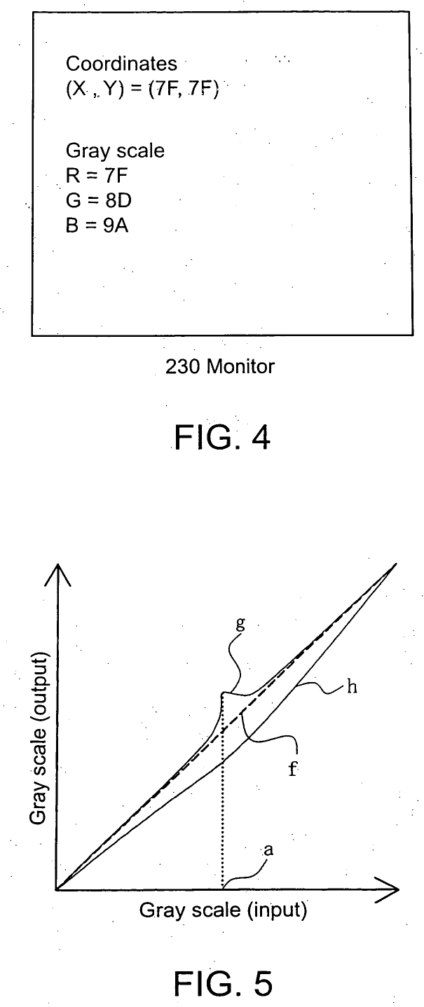

As the data receiving part 220 of the personal computer 200 receives the coordinates (x, y) and the gray scale (r, g, b) of the position transmitted from the controller 10, the display controller 250 displays the coordinates (x, y) and the gray scale (r, g, b) of the position on the monitor 230 as shown in FIG. 4.

The adjuster then sees the coordinates (x, y) and the gray scale (r, g, b) of the position of color adjustment specified by the cursor mark in the display of the monitor 230 of the personal computer 200.

Referring to these values, the adjuster adjusts the lookup tables for gray-scale correction included in the gray-scale correction part 60 using the personal computer 200, so as to obtain a desired color for the position.

More specifically, the adjuster first draws a gray-scale correction curve to obtain a desired color for the position by operating the keyboard 240 of the personal computer 200. FIG. 5 is a graph showing such gray-scale correction curves. The graph shows the input-output relation of the gray scale of the R signal component, with the input to the gray-scale correction part 60 plotted on the horizontal axis and the output from the gray-scale correction part 60 on the vertical axis. The dotted line “f” in the graph shows the input-output relation of the gray scale in initial condition. To increase an input gray-scale value around “a”, the adjuster inputs a desired value with the keyboard 240 and draws a curve “g” as shown in the graph. To decrease the whole gray scale of the R component, the adjuster draws a curve “h” as shown in the graph.

The adjuster then operates the keyboard 240 and sends out a command for data generation to the personal computer 200. In response, the personal computer 200 generates lookup table data for gray-scale correction based on the gray-scale correction curve, and sends the data to the controller 10 of the projector 100.

On receiving the generated lookup table data for gray-scale correction from the personal computer 200, the controller 10 accesses the gray-scale correction part 60 and replaces lookup table data for gray-scale correction stored in the gray-scale correction part 60 with the received lookup table data for gray-scale correction.

As a result, the gray-scale correction part 60 corrects the gray scale of each R, G, B signal component based on the replacing data, and thereby adjusting the color of the specified position in the image projected and displayed on the screen SCR so as to obtain a desired color for the position.

As for the projector 100 of the first exemplary embodiment as mentioned above, the adjuster operates the mouse 210 of the personal computer 200 during the gray-scale acquisition mode, and specifies the position of color adjustment with a cursor mark. Consequently, the coordinates and the gray scale of each R, G, B component of the specified position are displayed on the monitor 230. The adjuster therefore easily verifies whether colors that appear to be identical are actually identical or different, while watching the monitor 230 displaying the gray scale of each R, G, B component of the specified position. This enables the adjuster to make an image adjustment by adjusting lookup tables for gray-scale correction in the gray-scale correction part 60 based on the result of verification.

A second exemplary embodiment of the invention is described below. A projector according to the second exemplary embodiment has basically the same or similar configuration as the projector 100 of the first exemplary embodiment, and also performs the same operation as the projector 100 of the first exemplary embodiment until the controller 10 obtains the coordinates (x, y) of a position specified by a cursor mark and acquires the gray scale (r, g, b) of each R, G, B signal component of the position. Aspects of the second exemplary embodiment that are the same as the first exemplary embodiment are not described below.

The operation that is different from the first exemplary embodiment is described below. While the projector 100 of the first exemplary embodiment outputs the obtained coordinates (x, y) and the gray scale (r, g, b) of each R, G, B signal component of the specified position to the personal computer 200 by the exclusive cable, the projector according to the second exemplary embodiment does not output these values to the personal computer 200.

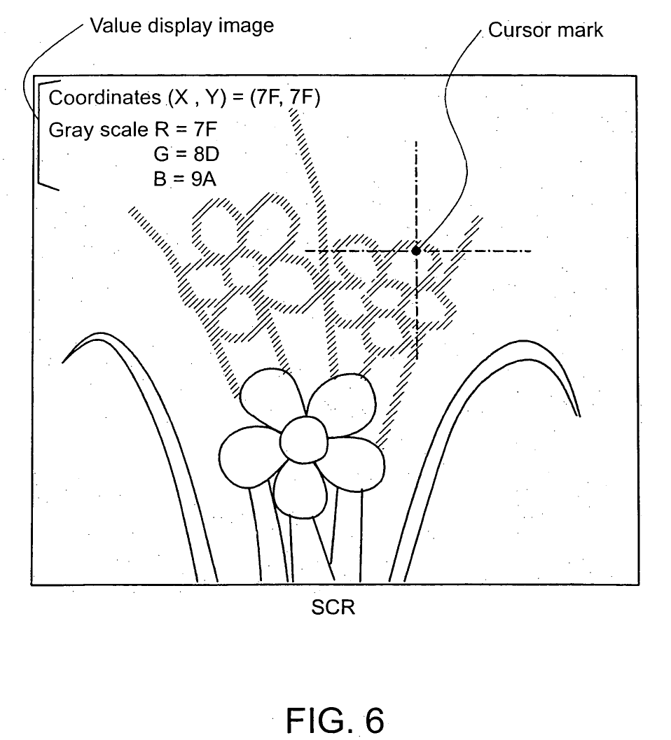

Instead, based on the obtained coordinates (x, y) and the gray scale (r, g, b) of each R, G, B component of the specified position, the controller 10 generates a display image showing these values and sends the image to the OSD part 50. The OSD part 50 superimposes the above image on an image formed by the image signal “VS2”. As a result, an image like the one shown in FIG. 6 is displayed on the screen SCR. FIG. 6 shows an image of flowers, a cursor mark at near center, and a value display image at upper left. It is desirable that the value display image and the image of flowers or the cursor mark do not overlap. It is also desirable that the value display image is displayed in a different color from the colors of the other images so that it stands out.

As for the projector of the second exemplary embodiment as mentioned above, the adjuster operates the mouse 210 of the personal computer 200 during the gray-scale acquisition mode, and specifies the position of adjustment with a cursor mark. Consequently, the coordinates and the gray scale of each R, G, B component of the position are projected and displayed on the screen SCR on which the cursor mark is also displayed. This enables the adjuster to easily verify whether colors that appear to be identical are actually identical or different, while watching the screen SCR displaying the gray scale of each R, G, B component of the specified position. Therefore, it is possible for the adjuster to make up new lookup tables for gray-scale correction based on the result of verification, and make an image adjustment by replacing original lookup tables for gray-scale correction stored in the gray-scale correction part 60 with the new lookup tables.

The invention is not limited to the above-mentioned exemplary embodiments, and can be modified in various ways without departing from the spirit and scope of the invention.

While the cursor mark is operated using the mouse 210 of the personal computer 200 in the exemplary embodiments, the invention is not limited to this structure. For example, the keyboard 240 of the personal computer 200 may be used for operating the cursor mark. Alternatively, the projector 100 may-include a remote-control receiver, so that the cursor mark can be operated using a remote-control device. Furthermore, the projector 100 may include cursor keys, so that the cursor mark can be operated using the cursor keys.

While the personal computer 200 displays the coordinates and the gray scale of the position on the monitor 230 of the computer when the data receiving part 220 receives the coordinates and the gray scale of the position transmitted from the controller 10 in the exemplary embodiments, the invention is not limited to this operation. For example, the projector 100 may include a liquid crystal display (not shown in the drawings), so that the coordinates and the gray scale obtained by the controller 10 can be displayed on the display.

While the controller 10 acquires the gray scale of each R, G, B component of the position specified by the cursor mark from the image signal “VS2” read out from the frame memory 40 in the exemplary embodiments, it is also possible to acquire these values from an image signal that is being stored in the frame memory 40.

While the exemplary embodiments use the projector 100 as an image display device, the invention is not limited to this structure. Examples of display devices may include a liquid crystal display, PDP, CRT, EL display, light-emitting diode display, and field emission display, for example.

What is claimed is:

1. An image display device for use with an external source and an image of an input image signal, comprising:
a superimposing part that superimposes a cursor image, on a position specified by the external source, located in the image of the input image signal;
a first display that displays an image processed by the superimposing part;
a gray-scale acquisition part that acquires gray scale of the image signal corresponding to the specified position from the image signal; and
a gray-scale output part that outputs the gray scale acquired by the gray-scale acquisition part.

2. An image display device for use with an external source and an image of an input image signal, comprising:
a superimposing part that superimposes a cursor image, on a position specified by the external source, located in the image of the input image signal;
a display that displays an image processed by the superimposing part; and
a gray-scale acquisition part that acquires gray scale of the image signal corresponding to the specified position from the image signal, the gray scale acquired by the gray-scale acquisition part being displayed on the display.

3. The image display device according to claim 2, further comprising:
a coordinate obtaining part that obtains coordinates of the specified position;
the coordinates obtained by the coordinate obtaining part and the gray scale being displayed on the display.

4. The image display device according to claim 1, the image display device being a projector.

5. An image display system, comprising:
the image display device according to claim 1; and
a computer coupled to the image display device, the computer including:
a second display; and
a gray-scale input part that inputs the gray scale output from the gray-scale output part, the gray scale input to the gray-scale input part being displayed on the second display.

6. The image display system according to claim 5, the image display device further including a coordinate obtaining part that obtains coordinates of the specified position, and the coordinates obtained by the coordinate obtaining part and the gray scale being displayed on the second display.
